(19) United States
(12) Patent Application Publication
(10) Pub. No.: US 2011/0222458 A1
(43) Pub. Date: Sep. 15, 2011

(54) Multi-user Downlink and Uplink Transmission Method and Communication System Using the Same

(76) Inventors: Cheng-Hsuan Wu, Taipei City (TW); Yen-Chin Liao, Taipei City (TW); Yung-Szu Tu, New Taipei City (TW)

(21) Appl. No.: 13/034,712

(22) Filed: Feb. 25, 2011

Related U.S. Application Data
(60) Provisional application No. 61/313,850, filed on Mar. 15, 2010.

(30) Foreign Application Priority Data
Dec. 24, 2010 (TW) 099145740

(51) Int. Cl. H04W 72/12

(52) U.S. Cl. 370/312

(57) ABSTRACT

The present invention discloses a multi-user (MU) downlink and downlink transmission method for a communication system. The communication system includes an access point (AP) and a plurality of stations. The MU transmission method includes steps of the AP deciding a first group of stations in a first scheduling period based on a channel condition, and the AP and the first group of stations performing simultaneously transmission during a MU media access control period.

### CROSS REFERENCE TO RELATED APPLICATIONS

This application claims the benefit of U.S. Provisional Application No. 61/313,850, filed on Mar. 15, 2010 and entitled “CONTENTION FREE AND CONTENTION BASED MULTI-USER MEDIA ACCESS CONTROL SCHEME WITH DOWNLINK AND UPLINK TRANSMISSION”, the contents of which are incorporated herein by reference.

### BACKGROUND OF THE INVENTION

1. Field of the Invention

The present invention relates to a multi-user (MU) downlink (DL) and uplink (UL) transmission method and communication system using the same, and more particularly, to a MU transmission method and communication system using the same capable of beginning simultaneously transmission with a DL transmission interval or an UL transmission interval in a contention free or a contention based media access control (MAC) protocol.

2. Description of the Prior Art

Reliable multicast or multi-user transmission in wireless communication is gaining importance with the development in technology. Applications like video streaming and multi-user file transfer need support of multicast or multi-user media access control protocol to improve the efficiency of point-to-point media access control as defined in IEEE 802.11n standard. Also, the issues of multi-user communications are widely discussed in the cutting edge standards such as WIMAX or IEEE 802.11ac.

Besides, please refer to FIG. 1, which is a schematic diagram of a conventional communication system including an access point (AP) AP′ and a station STA, i.e. a user. In the prior art, when performing point-to-point transmission, the access point AP′ and the station STA utilize request to send (RTS) and clear to send (CTS) packets to avoid data collision. For example, when the access point AP′ intends to transmit data to the station STA, the access point AP′ sends an RTS to the station STA first. When receives the RTS, the station STA responds a CTS to the access point AP'. When receiving the CTS, the access point AP′ starts transmitting the data. During this period, other stations will stop wireless data transmission when seeing the RTS or the CTS, so as to avoid data collision.

However, problems will happen when two stations simultaneously link with one access point. Data transmitted in two channels corresponding to the two stations may be interfered by each other if channel conditions of the two channels are similar, i.e. not entirely orthogonal to each other. Therefore, the traditional media access control (MAC) would prefer to working on a schedule base. That is, the traditional AP will arrange the schedule (time slots), frequency and antenna in order to transmit data to different stations, one station at one time slot.

### SUMMARY OF THE INVENTION

The objective of the present invention is to provide a MU transmission method and communication system using the same capable of performing simultaneously transmission in a DL transmission interval or an UL transmission interval in a contention free or a contention based media access control (MAC) protocol.

The present invention discloses a multi-user (MU) downlink (DL) and uplink (UL) transmission method for a communication system. The communication system includes an access point (AP) and a plurality of stations. The MU DL and UL transmission method includes steps of the AP deciding a first group of stations in a first scheduling period based on a channel condition, and the AP and the first group of stations of the plurality of stations performing simultaneously transmitting in a MU MAC (media access control, MAC) period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional communication system including an access point and a station.

FIG. 2 is a schematic diagram of a multi-user (MU) downlink (DL) and uplink (UL) transmission process for a communication system according to an embodiment of the present invention.

FIG. 3 and FIG. 4 are schematic diagrams of beginning MU transmission with a DL transmission interval and an UL transmission interval in a contention free MAC protocol according to an embodiment of the present invention, respectively.

FIG. 5 and FIG. 6 are schematic diagrams of beginning MU transmission with a DL transmission interval and an UL transmission interval in a contention based MAC protocol according to an embodiment of the present invention, respectively.

FIG. 7 is a schematic diagram of an AP and 3 stations performing MU transmission according to an embodiment of the present invention.

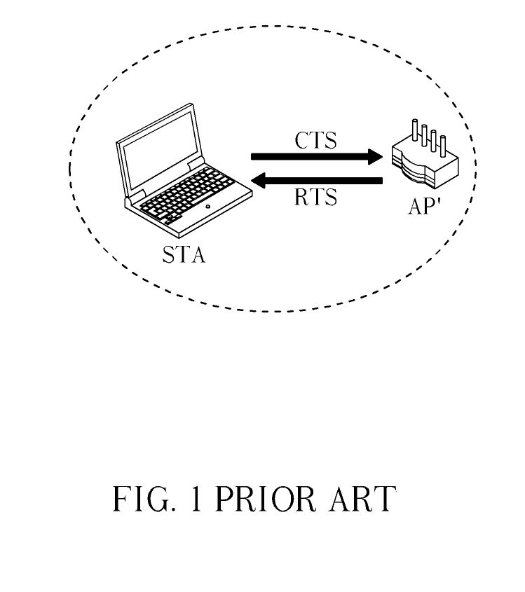

### DETAILED DESCRIPTION

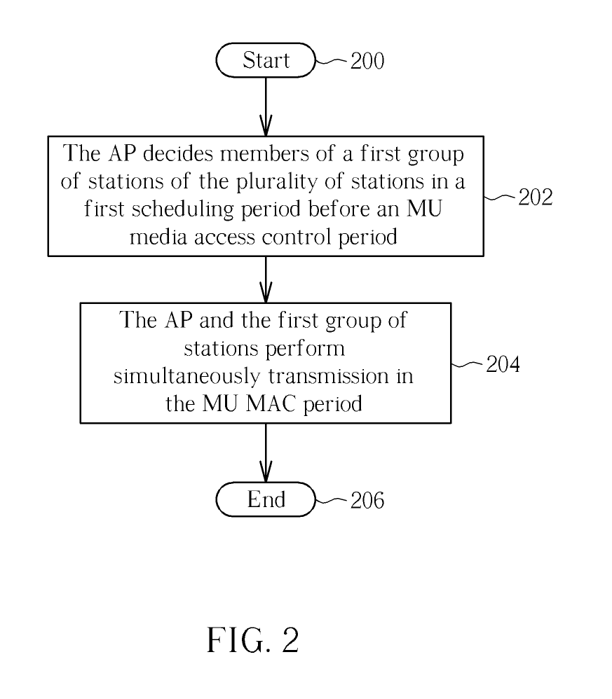

Please refer to FIG. 2, which is a schematic diagram of a multi-user (MU) downlink (DL) and uplink (UL) transmission process 20 for a communication system according to an embodiment of the present invention. The communication system includes an access point (AP) and a plurality of stations, i.e. users. The MU DL and UL transmission process 20 is utilized for enable the AP to perform simultaneously transmission with a plurality of stations. The MU DL and UL transmission process 20 includes the following steps:

Step 200: Start.

Step 202: The AP decides members of a first group of stations of the plurality of stations in a first scheduling period before a MU media access control (MAC) period.

Step 204: The AP and the first group of stations perform simultaneously transmission in the MU MAC period.

Step 206: End.

According to the MU DL and UL transmission process 20, the AP decides members of a first group of stations (i.e. scheduling result) in a first scheduling period before a MU MAC period. Then, the AP and the first group of stations perform simultaneously transmission in the MU MAC period.

Specifically, in the first scheduling period, the AP decides stations with channels that are not substantially orthogonal as members of the first group of stations based on channel conditions, e.g. channel state information (CSI), receive beam-forming information, and quality of service (QoS) requirements etc., of a plurality of downlink (DL) channels corresponding to the plurality of stations. In such a situation, the AP can simultaneously transmit data to the first group of stations in DL channels by spatial division multiple access (SDMA) according to a scheduling result of the first scheduling period without interfering. Furthermore, generally, DL channels and corresponding uplink (UL) channels have reciprocity. That is, a DL channel for the AP to a station and an UL channel for the station to the AP have the same physical characteristics. Thus, the first group of stations can also simultaneously transmit data to the AP in UL channels by SDMA according to the scheduling result of the first scheduling period without interfering, which simplifies complexity of UL transmission. As a result, the AP and the stations of the communication system can perform simultaneously transmission to increase data throughput.

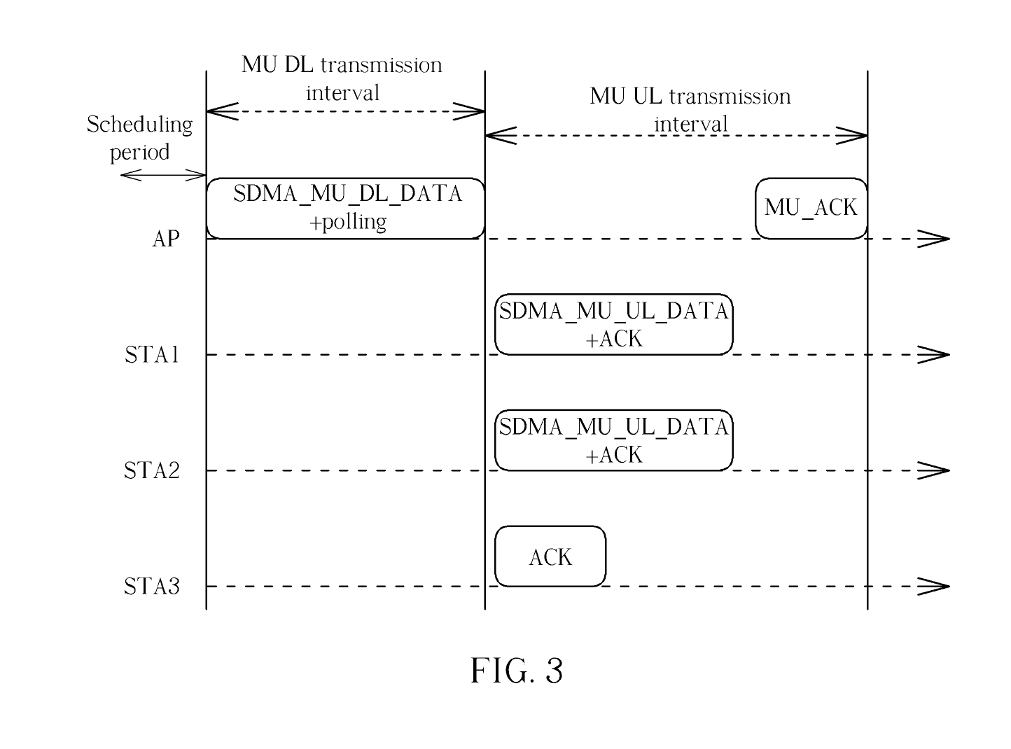

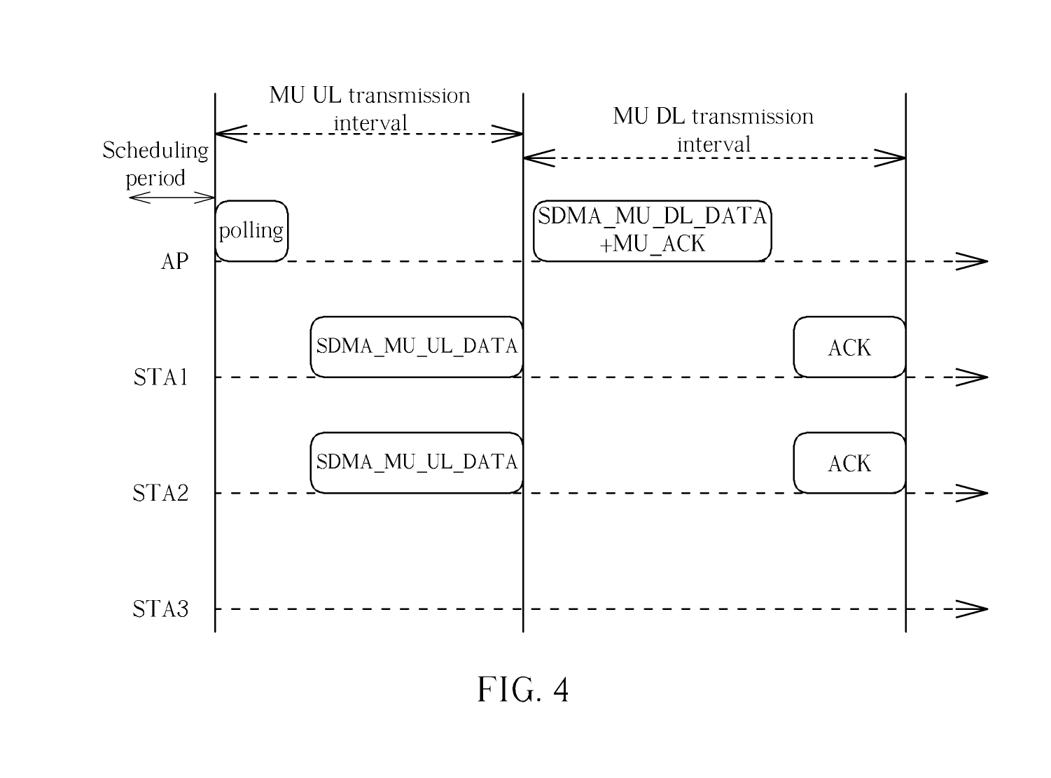

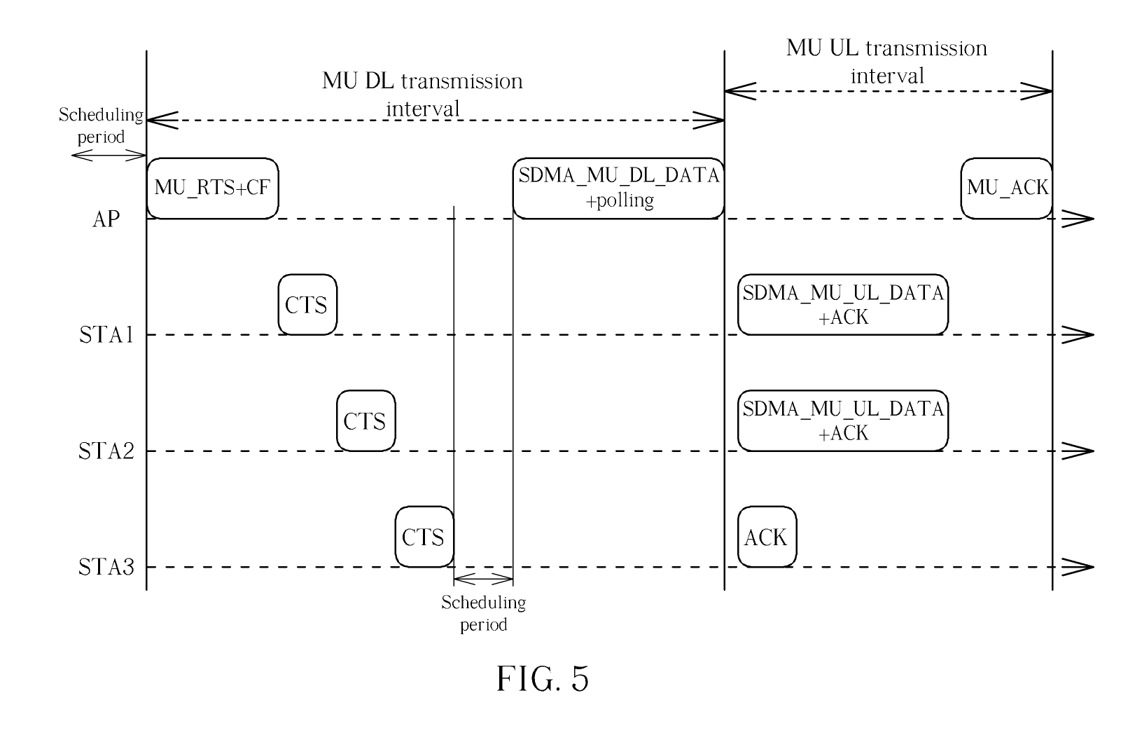

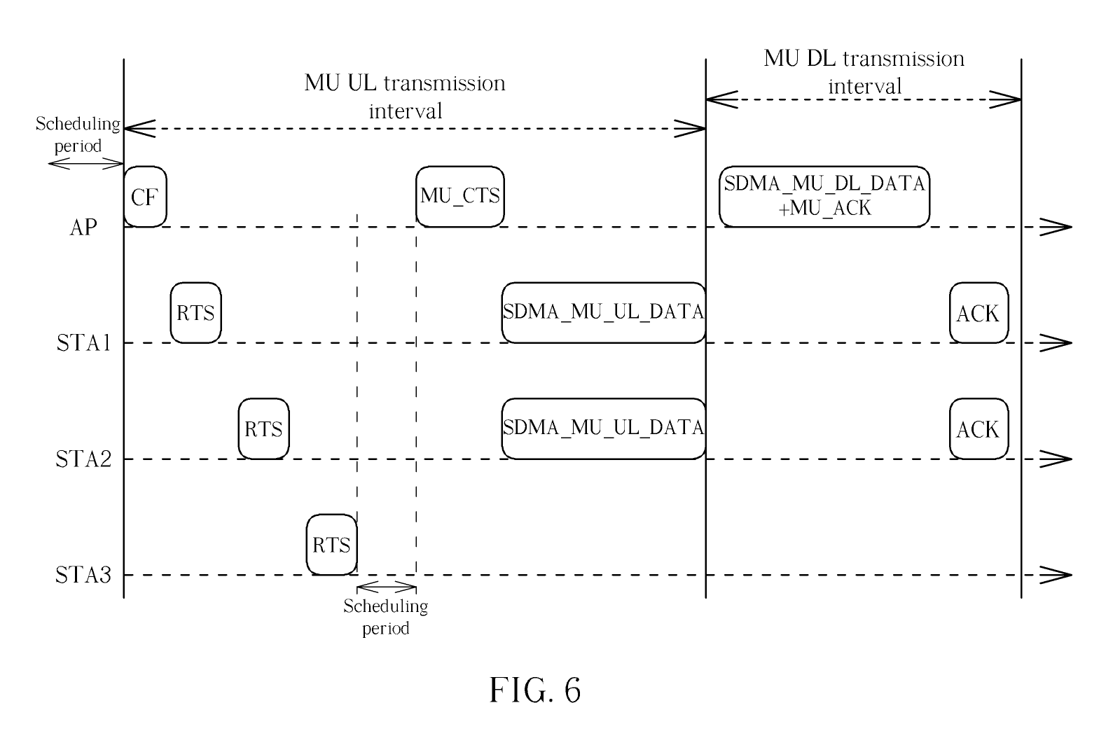

Please refer to FIG. 3 to FIG. 6. FIG. 3 and FIG. 4 are schematic diagrams of beginning MU transmission with a DL transmission interval and an UL transmission interval in a contention free MAC protocol according to an embodiment of the present invention, respectively, and FIG. 5 and FIG. 6 are schematic diagrams of beginning MU transmission with a DL transmission interval and an UL transmission interval in a contention based MAC protocol according to an embodiment of the present invention, respectively. In FIG. 3 to FIG. 6, in a scheduling period before a MU MAC period, an AP decides stations STA1-STA3 are members of stations with which the AP can simultaneously perform DL data transmission in the MU MAC period, i.e. the members of the first group of stations of the MU DL and UL transmission process 20, naming the scheduling result. Then, since DL channels and UL channels have reciprocity, the stations STA1-STA3 also can simultaneously perform UL data transmission with the AP according to the scheduling result of the first scheduling period. As a result, as mentioned above, since channel conditions between the AP and the stations STA1-STA3 are substantially orthogonal, the AP and the stations STA1-STA3 can perform DL data and UL data transmission by SDMA, to improve MAC efficiency with low complexity, and to increase data throughput. Following are detailed illustrations of MU transmission shown in FIG. 3 to FIG. 6.

As shown in FIG. 3, in the case of beginning with a DL transmission interval in the contention free MAC protocol, the AP transmits a MU DL data, an UL information and a polling message to the stations STA1-STA3 in a DL transmission interval after the scheduling period, by SDMA. The MU DL data includes individual data that the AP intends to transmit to the stations STA1-STA3. Noticeably, the UL information includes information for MU UL transmission such as antenna configuration etc., and can be optionally transmitted for the stations STA1-STA3 to perform UL transmission accordingly. The polling message is utilized for inquiring the stations STA1-STA3 to check whether there is data for transmission. If the MU DL data includes inquiring functions, the AP does not need to transmit the polling message. Then, after receiving the MU DL data, the UL information and the polling message, the stations STA1-STA3 can respond in an UL transmission interval by SDMA according to the UL information. Noticeably, since the station STA3 does not have UL data to respond, it only needs to send back a corresponding acknowledgement (ACK) to the AP, and each of the stations STA1-STA2 respond a corresponding MU UL data and a corresponding ACK message to the AP. Finally, after receiving all corresponding MU UL data responded by the stations STA1-STA2, the AP responds a MU ACK message to the stations STA1-STA2.

As shown in FIG. 4, in the case of beginning with an UL transmission interval in the contention free MAC protocol, the AP transmits a polling message and an UL information to the stations STA1-STA3 in an UL transmission interval after the scheduling period. The polling message is utilized for inquiring the stations STA1-STA3 to check whether there is data for transmission. The UL information includes information for MU UL transmission such as antenna configuration etc., and can be optionally transmitted for the stations STA1-STA3 to perform UL transmission accordingly. After receiving the polling message and the UL information, the station STA3 does not have data for transmission and thus does not respond, while the stations STA1-STA2 have data for transmission and thus each simultaneously responds a corresponding MU UL data to the AP by SDMA according to the UL information, respectively. Then, after receiving all corresponding MU UL data responded by the stations STA1-STA2, the AP simultaneously responds a MU DL data and a MU ACK message to the stations STA1-STA2 by SDMA in a DL transmission interval. The MU DL data includes respective data that the AP intends to transmit to each of the stations STA1-STA2. Finally, after receiving MU DL data, each of the stations STA1-STA2 can simultaneously respond a corresponding ACK message to the AP by SDMA.

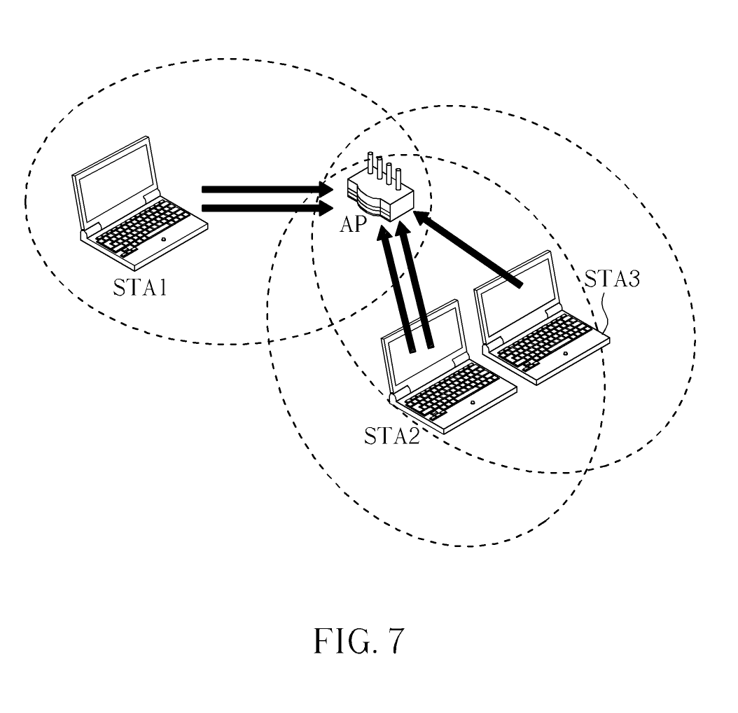

As shown in FIG. 5, in the case of beginning with a DL transmission interval in the contention based MAC protocol, the AP transmits a MU request to send (RTS) and a control frame (CF) to the stations STA1-STA3 in a DL transmission interval after the scheduling period. After receiving the MU RTS and the CF, each of the stations STA1-STA3 responds a corresponding clear to send (CTS) to the AP by Time Division Multiple Access (TDMA) at a respective predefined time indicated by the CF, e.g. the station STA2 responds a corresponding CTS after the station STA1, and the station STA3 responds a corresponding CTS after the station STA2, to avoid a hidden terminal problem which may be caused by SDMA. For example, please refer to FIG. 7, which is a schematic diagram of the AP and the 3 stations STA1-STA3 performing MU transmission according to an embodiment of the present invention. If the stations STA2 and STA3 respond the CTSs by SDMA rather than TDMA, data collision may occur when the stations STA2 and STA3 simultaneously respond to the CTSs.

Noticeably, after receiving all CTSs responded by the stations STA1-STA3, the AP can redecide stations of the stations STA1-STA3 with channel conditions not similar to each other, i.e. substantially orthogonal, according to all the CTSs responded by the stations STA1-STA3 in another scheduling period, to perform simultaneously transmission. The above operations are performed because channel conditions which the previous scheduling is based on may be not updated for too long and thus not accurate. Therefore, the AP can accurately redecide stations of the stations STA1-STA3 with current channel conditions not similar to each other according to all the CTSs responded by the stations STA1-STA3, to perform simultaneously transmission.

For example, assuming the stations STA1-STA3 are of channel conditions not similar to each other, after receiving all the CTSs responded by the stations STA1-STA3, the AP transmits a MU DL data, an UL information and a polling message to the stations STA1-STA3 by SDMA according to a second scheduling result. Noticeably, in another embodiment, stations of the stations STA1-STA3 with similar channel conditions do not simultaneously perform transmission. The MU DL data includes respective data which the AP intends to transmit to the stations STA1-STA3. Noticeably, the UL information includes information for MU UL transmission such as antenna configuration etc., and can be optionally transmitted for the stations STA1-STA3 to perform UL transmission accordingly. The polling message is utilized for inquiring the stations STA1-STA3 to check whether there is data for transmission. If the MU DL data includes inquiring functions, the AP does not need to transmit the polling message. Then, after receiving the MU DL data, the UL information and the polling message, the stations STA1-STA3 can respond in an UL transmission interval by SDMA according to the UL information. Noticeably, since the station STA3 does not have UL data to respond, the station STA3 only needs to send back a corresponding ACK to the AP, and each of the stations STA1-STA2 respond a corresponding MU UL data and a corresponding ACK message to the AP. Finally, after receiving all corresponding MU UL data responded by the stations STA1-STA2, the AP responds a MU ACK message to the stations STA1-STA2.

As shown in FIG. 6, in the case of beginning with an UL transmission interval in the contention based MAC protocol, the AP transmits a CF (control frame) to the stations STA1-STA3 in an UL transmission interval after the scheduling period. After receiving the CF, each of the stations STA1-STA3 responds a corresponding request to send (RTS) to the AP by TDMA at a respective predefined time indicated by the CF, e.g. the station STA2 responds a corresponding RTS after the station STA1, and the station STA3 responds a corresponding RTS after the station STA2, to avoid a hidden terminal problem which may be caused by SDMA.

Noticeably, after receiving all RTSs responded by the stations STA1-STA3, the AP can redecide stations of the stations STA1-STA3 with channel conditions not similar to each other, i.e. substantially orthogonal, according to all the RTSs responded by the stations STA1-STA3 in another scheduling period, to perform simultaneously transmission. The above operations may be inaccurate when the channel conditions which the previous scheduling is based on are readily updated. Therefore, now, the AP can accurately redecide stations of the stations STA1-STA3 with current channel conditions not similar to each other based on the RTSs responded by the stations STA1-STA3, to perform simultaneously transmission.

For example, assuming the stations STA1-STA3 are of channel conditions that are not similar to each other, after receiving all the RTSs responded by the stations STA1-STA3, the AP transmits a MU CTS and an UL information to the stations STA1-STA3 according to a second scheduling result. Noticeably, in another embodiment, stations of the stations STA1-STA3 with similar channel conditions do not simultaneously perform transmission. The UL information includes information for MU UL transmission such as antenna configuration etc., and can be optionally transmitted for the stations STA1-STA3 to perform UL transmission accordingly. After receiving the MU CTS and the UL information, the station STA3 does not have data for transmission and thus does not respond, while the stations STA1-STA2 have data for transmission and thus each simultaneously responds a corresponding MU UL data to the AP by SDMA according to the UL information, respectively. Then, after receiving all corresponding MU UL data responded by the stations STA1-STA2, the AP simultaneously responds a MU DL data and a MU ACK message to the stations STA1-STA2 by SDMA in a DL transmission interval. The MU DL data includes respective data which the AP intends to transmit to each of the stations STA1-STA2. Finally, after receiving MU DL data, each of the stations STA1-STA2 can simultaneously respond a corresponding ACK message to the AP by SDMA.

Noticeably, the spirit of the present invention is that the AP can perform simultaneously DL transmission with stations having channel conditions not similar to each other, i.e. substantially orthogonal, while the above stations having channel conditions not similar to each other can simultaneously perform UL transmission with the AP due to reciprocity of DL channels and UL channels. Those skilled in the art should make modifications or alterations accordingly. For example, if the AP has known some stations with channel conditions not similar to each other, the AP can directly transmit to the some stations without scheduling, and the some stations also can directly transmit to the AP without basing on the UL information, i.e. the AP can optionally not transmit the UL information. Besides, in the embodiments shown in FIG. 5 and FIG. 6, after receiving all the CTSs or RTSs responded by the stations STA1-STA3, the AP redecides stations of the stations STA1-STA3 with channel conditions not similar to each other, i.e. substantially orthogonal, according to all the CTSs or RTSs responded by the stations STA1-STA3 in another scheduling period, to perform simultaneously transmission, so as to further accurately redecide stations of the stations STA1-STA3 with current channel conditions not similar to each other and thus avoid interfering, However, if the AP is sure that the stations STA1-STA3 are not interfering with each other, the second scheduling can be skipped.

On the other hand, in respect to realization, the MU DL and UL transmission process 20 can be transformed into a program by software, firmware etc, such that a communication device including an AP and a plurality of stations can execute steps of the MU DL and UL transmission process 20. Such transforming the MU DL and UL transmission process 20 into a proper program to realize corresponding device should be known by those skilled in the art.

In the prior art, the AP arranges the schedule (time slots), frequency and antenna to transmit data to different stations, i.e. still only one station can link with the AP at one time slot. In comparison, in the present invention, the AP can perform simultaneously DL transmission with stations having channel conditions not similar to each other, i.e. substantially orthogonal, while the above stations having channel conditions not similar to each other can simultaneously perform UL transmission with the AP due to reciprocity of DL channels and UL channels. Besides, the present invention also provides embodiments of MU DL and UL transmission methods for beginning simultaneously transmission with a DL transmission interval or an UL transmission interval in contention free or contention based MAC protocols.

To sum up, in the present invention, the AP and stations can perform simultaneously transmission.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-user (MU) downlink (DL) and uplink (UL) transmission method for a communication system, the communication system comprising an access point (AP) and a plurality of stations, the MU DL and UL transmission method comprising:
the AP deciding a first group of stations in a first scheduling period based on a channel condition, and
the AP and the first group of stations simultaneously performing transmission in a MU media access control (MAC) period.

2. The MU DL and UL transmission method of claim 1, wherein a scheduling result of the AP can be utilized in DL data transmission of the AP and UL data transmission of the plurality of stations.

3. The MU DL and UL transmission method of claim 1, wherein the AP and the first group of stations simultaneously perform transmission by spatial division multiplex access (SDMA).

4. The MU DL and UL transmission method of claim 1, wherein the MU DL and UL transmission method is utilized in a contention free MAC protocol.

5. The MU DL and UL transmission method of claim 4, wherein the step of the AP and the first group of stations simultaneously performing transmission in the MU MAC period comprising:
the AP transmitting a MU DL data to the first group of stations by SDMA in a DL transmission interval of the MU MAC period.

6. The MU DL and UL transmission method of claim 5, wherein the step of the AP transmitting the MU DL data to the first group of stations by SDMA in the DL transmission interval of the MU MAC period further comprising:
the AP transmitting the MU DL data, an UL information and a polling message to the first group of stations by SDMA in the DL transmission interval of the MU MAC period.

7. The MU DL and UL transmission method of claim 5 further comprising:
each of the first group of stations responding a corresponding acknowledgement (ACK) message to the AP in an UL transmission interval of the MU MAC period after receiving the MU DL data.

8. The MU DL and UL transmission method of claim 5 further comprising:
at least one of the stations of the first group of stations simultaneously responding a corresponding MU UL data and a corresponding ACK message to the AP by SDMA according to an UL information in an UL transmission interval of the MU MAC period after receiving the MU DL data.

9. The MU DL and UL transmission method of claim 8, further comprising:
the AP responding a MU ACK message to the stations after receiving all corresponding MU UL data responded by the stations.

10. The MU DL and UL transmission method of claim 4, wherein the step of the AP and the first group of stations performing simultaneous transmission in a MU MAC period comprising:
the AP transmitting a polling message to the first group of station in an UL transmission interval of the MU MAC period.

11. The MU DL and UL transmission method of claim 10 further comprising:
at least one stations of the first group of stations simultaneously responding a corresponding MU UL data to the AP by SDMA according to an UL information after receiving the polling message.

12. The MU DL and UL transmission method of claim 11 further comprising:
the AP simultaneously responding a MU DL data and a MU ACK message to the stations by SDMA in a DL transmission interval of the MU MAC period after receiving all corresponding MU UL data responded by the stations.

13. The MU DL and UL transmission method of claim 12 further comprising:
at least one of the stations responding a corresponding ACK message to the AP after receiving the MU DL data.

14. The MU DL and UL transmission method of claim 1, wherein the MU DL and UL transmission method is utilized in a contention based MAC protocol.

15. The MU DL and UL transmission method of claim 14, wherein the step of the AP and the first group of stations performing simultaneous transmission in the MU MAC period comprising:
the AP transmitting a MU request to send (RTS) and a control frame (CF) to the first group of station in a DL transmission interval of the MU MAC period.

16. The MU DL and UL transmission method of claim 15 further comprising:
each of the first group of stations responding a corresponding clear to send (CTS) to the AP by Time Division Multiple Access (TDMA) at a respective predefined time indicated by the CF after receiving the MU RTS and the CF.

17. The MU DL and UL transmission method of claim 16 further comprising the AP redeciding members of the first group of stations in a second scheduling period according to all the CTSs responded by the first group of stations after receiving all the CTSs responded by the first group of stations.

18. The MU DL and UL transmission method of claim 16 further comprising:
the AP transmitting a MU DL data to the first group of station by SDMA after receiving all the CTSs responded by the first group of stations.

19. The MU DL and UL transmission method of claim 18, wherein the step of the AP transmitting a MU DL data to the first group of station by SDMA after receiving all the CTSs responded by the first group of stations further comprises:
the AP transmitting the MU DL data, an UL information and a polling message to the first group of stations by SDMA after receiving all the CTSs responded by the first group of stations.

20. The MU DL and UL transmission method of claim 18 further comprising:
each of the first group of stations responding a corresponding ACK message to the AP in an UL transmission interval of the MU MAC period after receiving the MU DL data.

21. The MU DL and UL transmission method of claim 18 further comprising:
at least one of stations of the first group of stations simultaneously responding a corresponding MU UL data and a corresponding ACK message to the AP by SDMA according to an UL information in an UL transmission interval of the MU MAC period after receiving the MU DL data.

22. The MU DL and UL transmission method of claim 21 further comprising:
the AP responding a MU ACK message to the stations after receiving all corresponding MU UL data responded by the stations.

23. The MU DL and UL transmission method of claim 14, wherein the step of the AP and the first group of stations performing simultaneous transmission in the MU MAC period comprising:
the AP transmitting a CF to the first group of stations in an UL transmission interval of the MU MAC period.

24. The MU DL and UL transmission method of claim 23 further comprising each of the first group of stations responding a corresponding RTS to the AP by TDMA at a respective predefined time indicated by the CF after receiving the CF.

25. The MU DL and UL transmission method of claim 23 further comprising the AP redeciding members of the first group of stations in a second scheduling period according to all the RTSs responded by the first group of stations after receiving all the RTSs responded by the first group of stations.

26. The MU DL and UL transmission method of claim 23 further comprising:
the AP transmitting a MU CTS to the first group of stations after receiving all the RTSs responded by the first group of stations.

27. The MU DL and UL transmission method of claim 26 further comprising:
at least one of the stations of the first group of stations simultaneously responding a corresponding MU UL data to the AP by SDMA according to an UL information after receiving the MU CTS.

28. The MU DL and UL transmission method of claim 27 further comprising:
the AP simultaneously responding a MU DL data and a MU ACK message to the stations by SDMA in a DL transmission interval of the MU MAC period after receiving all corresponding MU UL data responded by the stations.

29. The MU DL and UL transmission method of claim 28 further comprising:
at least one of the stations responding a corresponding ACK message to the AP after receiving the MU DL data.

30. A communication system comprising an access point (AP) and a plurality of station, for executing the MU DL and UL transmission method of claim 1.
